(19) United States
(12) Patent Application Publication
(10) Pub. No.: US 2021/0221135 A1
(43) Pub. Date: Jul. 22, 2021

(54) INKJET CHIP AND THERMAL BUBBLE INKJET PRINTHEAD USING THE SAME

(71) Applicant: International United Technology Co., Ltd., Hsin-Chu (TW)

(72) Inventors: Yuan-Liang Lan, Hsinchu County (TW); Chih-Shun Chuang, Hsinchu City (TW); Chao-Cheng Lan, Hsinchu City (TW)

(73) Assignee: International United Technology Co., Ltd., Hsin-Chu (TW)

(21) Appl. No.: 17/152,809

(22) Filed: Jan. 20, 2021

Related U.S. Application Data
(60) Provisional application No. 62/963,555, filed on Jan. 21, 2020.

(51) Int. Cl. B41J 2/14

(52) U.S. Cl. CPC B41J 2/14112; B41J 2/14072

(57) ABSTRACT

A thermal bubble inkjet printhead including a substrate, a plurality of control elements, a plurality of heaters, an ink barrier and a nozzle plate is provided. The control elements are disposed on the substrate. The heaters are electrically connected to the control elements. The material of the heaters is a transparent conductive material. The ink barrier is disposed on the heater and has a plurality of ink chambers. Each of the ink chambers overlaps one of the heaters. The nozzle plate is disposed on the ink barrier and has a plurality of nozzles. Each nozzle overlaps one of the ink chambers.

### CROSS-REFERENCE TO RELATED APPLICATION

This application claims the priority benefit of U.S. provisional application serial no. 62/963,555, filed on Jan. 21, 2020. The entirety of the above-mentioned patent application is hereby incorporated by reference herein and made a part of this specification.

### BACKGROUND

### Technical Field

The disclosure relates to inkjet printing device, and in particular, to an inkjet chip and a thermal bubble inkjet printhead.

### Description of Related Art

Inkjet printing technique has been broadly applied to printing equipment. According to the inkjet printing technique, droplets of ink is jetted onto a print medium to form ink dots on the print medium, such that an image or text is formed on the print medium by these ink dots. The most popular inkjet printing techniques include piezoelectric inkjet printing and thermal bubble inkjet printing. According to thermal bubble inkjet printing, ink is vaporized instantaneously by heaters in the inkjet printhead for producing high-pressure bubbles, and the ink is then ejected through nozzles to form droplets of ink.

Generally, the inkjet printhead is formed on the silicon substrate whose size is 2 inch at most, so that it is difficult to create a large-size inkjet chip with size greater than 4 inches. Therefore, using multiple inkjet printheads to splice each other into a large-size inkjet printhead is proposed. However, additional equipment/cost is required to perform splicing of the smaller inkjet printheads. Besides, the image printed by such splicing inkjet printhead may have a gap, depending on the processing accuracy and alignment precision, at a position corresponding to the splicing position of the smaller inkjet printheads. Therefore, an inkjet printhead capable of printing large-size image without the aforesaid problem is still desired.

### SUMMARY

The disclosure provides an inkjet chip having transparent heaters.

The disclosure provides a thermal bubble inkjet printhead capable of printing a large size of image with good quality.

The thermal bubble inkjet printhead of the disclosure includes: a substrate, a plurality of control elements, a plurality of heaters, an ink barrier and a nozzle plate. The control elements are disposed on the substrate. The heaters are electrically connected to the control elements. The material of the heaters is a transparent conductive material. The ink barrier is disposed on the heater and has a plurality of ink chambers. Each of the ink barriers overlaps one of the heaters. The nozzle plate is disposed on the ink barrier and has a plurality of nozzles. Each nozzle overlaps one of the ink chambers.

In the thermal bubble inkjet printhead according to an embodiment of the disclosure, the control elements are thin film transistors.

In the thermal bubble inkjet printhead according to an embodiment of the disclosure, the material of the heater includes metal oxides.

In an embodiment of the disclosure, the thermal bubble inkjet printhead further comprises a passivation layer covering the heaters. The ink chambers of the ink barrier expose a part of a surface of the passivation layer. The material of the passivation layer includes silicon nitride, silicon carbide, tantalum, or a combination thereof

In an embodiment of the disclosure, the thermal bubble inkjet printhead further comprises a first insulating layer, a second insulating layer and a metal conductive layer. The first insulating layer and the second insulating layer are disposed between the control element and the heater. The metal conductive layer is disposed between the first insulating layer and the second insulating layer. Each of the heaters is electrically connected to one of the control elements via a conductive pattern of the metal conductive layer.

In the thermal bubble inkjet printhead according to an embodiment of the disclosure, each of the control elements includes a semiconductor pattern, a gate electrode, a source electrode and a drain electrode. The semiconductor pattern has a channel region, a source region and a drain region. The source region and the drain region are disposed on two opposite sides of the channel region. The gate electrode overlaps the channel region of the semiconductor pattern. The source electrode and the drain electrode are electrically connected to the source region and the drain region of the semiconductor pattern, respectively. The gate electrode belongs to a first metal conductive layer. The source electrode and the drain electrode belong to a second metal conductive layer. An interlayer dielectric layer is provided between the first metal conductive layer and the second metal conductive layer. The heaters directly cover the interlayer dielectric layer and are electrically connected to the drain electrodes of the control elements, respectively.

In the thermal bubble inkjet printhead according to an embodiment of the disclosure, the film thickness of each heater is between 30 nm and 100 nm.

In the thermal bubble inkjet printhead according to an embodiment of the disclosure, the sheet resistance of each heater is between 10 Ω/sq and 70 Ω/sq.

The inkjet chip of the disclosure includes: a substrate, a plurality of control elements and a plurality of heaters. The control elements are disposed on the substrate. The heaters are electrically connected to the control elements. The material of the heaters is a transparent conductive material.

In the inkjet chip according to an embodiment of the disclosure, the control elements are thin film transistors.

In the inkjet chip according to an embodiment of the disclosure, the material of the heaters includes metal oxides.

In an embodiment of the disclosure, the inkjet chip further comprises a passivation layer covering the heaters. The material of the passivation layer includes silicon nitride, silicon carbide, tantalum, or a combination thereof.

In an embodiment of the disclosure, the inkjet chip further comprises a first insulating layer, a second insulating layer and a metal conductive layer. The first insulating layer and the second insulating layer are disposed between the control elements and the heaters. The metal conductive layer is disposed between the first insulating layer and the second insulating layer. Each of the heaters is electrically connected to one of the control elements via a conductive pattern of the metal conductive layer.

In the inkjet chip according to an embodiment of the disclosure, the control element includes a semiconductor pattern, a gate electrode, a source electrode and a drain electrode. The semiconductor pattern has a channel region, a source region and a drain region. The source region and the drain region are disposed on two opposite sides of the channel region. The gate electrode overlaps the channel region of the semiconductor pattern. The source electrode and the drain electrode are electrically connected to the source region and the drain region of the semiconductor pattern, respectively. The gate electrode belongs to a first metal conductive layer. The source electrode and the drain electrode belong to a second metal conductive layer. An interlayer dielectric layer is provided between the first metal conductive layer and the second metal conductive layer. The heaters directly cover the interlayer dielectric layer and are electrically connected to the drain electrodes of the control elements, respectively.

In the inkjet chip according to an embodiment of the disclosure, the film thickness of each heater is between 30 nm and 100 nm.

In the inkjet chip according to an embodiment of the disclosure, the sheet resistance of each heater is between 10 Ω/sq and 70 Ω/sq.

Based on the foregoing, the thermal bubble inkjet printhead provided in an embodiment of the disclosure can achieve large-size printing with one inkjet chip whose size may equal to or greater than 4 inches. Specifically, the thermal bubble inkjet printhead of the present invention is not formed by splicing multiple inkjet chips with smaller size so that the quality of printed image can be improved. Besides, the usage of a transparent conductive material to form the heaters of the inkjet chip leads to higher reliability of the inkjet chip and lower cost of thermal bubble inkjet printhead.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of a thermal bubble inkjet printhead according to a first embodiment of the invention.

FIG. 2 is a schematic cross-sectional view of a thermal bubble inkjet printhead according to a second embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

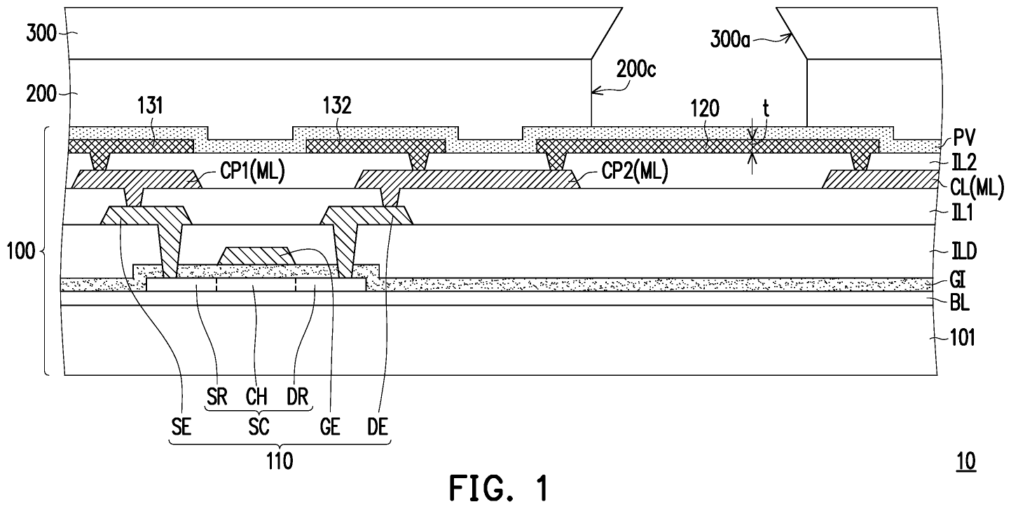

FIG. 1 is a schematic cross-sectional view of a thermal bubble inkjet printhead according to a first embodiment of the invention. Referring to FIG. 1, the thermal bubble inkjet printhead 10 comprises an inkjet chip 100, an ink barrier 200 and a nozzle plate 300. The ink barrier 200 is disposed between the inkjet chip 100 and the nozzle plate 300. The inkjet chip 100 includes a substrate 101, a plurality of control elements 110 and a plurality of heaters 120. These control elements 110 are distributed on the substrate 101. The heaters 120 are respectively electrically connected to the control elements 110. The on/off state of each heater 120 can be switched by one of the control elements 110.

It is worth noting that since the substrate 101 of present embodiment is a glass substrate, the size of inkjet chip 100 can be greater than 4 inch. That means, the size of the inkjet chip 100 is not limited to the size of conventional silicon substrate/wafer, so that the thermal bubble inkjet printhead 10 can merely contain one inkjet chip 100. In other words, there is no need to splice multiple inkjet chips with smaller size into the thermal bubble inkjet printhead 10 so that the quality of printed image can be effectively improved. However, the invention is not limited thereto. In other embodiments, the material of the substrate 101 may also include quartz, polyimide (PI), polycarbonate (PC), polyethylene terephthalate (PET), or another suitable polymer material.

In the present embodiment, for example, the control element 110 may be a thin film transistor (TFT), for example, a low temperature polysilicon (LTPS) TFT, but the invention is not limited thereto. In other embodiments, the control element 110 may also be an amorphous silicon (a-Si) TFT, a microcrystalline silicon (micro-Si) TFT or a metal oxide transistor. In the present embodiment, the method of forming the control element 110 may include the following steps: a semiconductor pattern SC, a gate insulator GI, a gate electrode GE, an interlayer dielectric layer ILD, a source electrode SE and a drain electrode DE are sequentially formed on the substrate 101.

The gate electrodes GE of the control elements 110 may belong to a first metal conductive layer, and the source electrodes SE and the drain electrodes DE of the control elements 110 may belong to a second metal conductive layer. Generally, the gate electrode GE, the source electrode SE and the drain electrode DE are formed by using metal material (for example, Al, Mo, Au, Cu, Ta, a combination thereof, or an alloy thereof) basing on the consideration of conductivity.

The semiconductor pattern SC has a source region SR, a drain region DR and a channel region CH. The source region SR and the drain region DR are located on two opposite sides of the channel region CH. The source electrode SE and the drain electrode DE penetrate the interlayer dielectric layer ILD and the gate insulator GI to electrically connect the source region SR and the drain region DR of the semiconductor pattern SC, respectively. For example, the gate electrode GE of the control element 110 can be selectively arranged above the semiconductor pattern SC to form a top-gate TFT, but the invention is not limited thereto. In other embodiments, the gate electrode GE of the control element may also be arranged below the semiconductor pattern SC to form a bottom-gate TFT. In the present embodiment, the material of the semiconductor pattern SC is, for example, a polysilicon semiconductor material, but the invention is not limited thereto.

In addition, the inkjet chip 100 further includes a buffer layer BL disposed between the substrate 101 and the semiconductor pattern SC (or gate insulator GI). It should be noted that the gate insulator GI, the buffer layer BL and the interlayer dielectric layer ILD can be fulfilled by any method well-known in the art to form any gate insulator, any buffer layer and any interlayer dielectric layer used in a display panel. Therefore, information (for example, formation method and composition) about the buffer layer BL, the gate insulator GI and the interlayer dielectric layer ILD will not be described in detail here. For example, the composition of buffer layer BL, interlayer dielectric layer ILD and the gate insulator GI may include SiN, SiO₂ or SiOₓN_{y}, but the invention is not limited thereto.

In the present embodiment, the inkjet chip 100 may further comprises a first insulating layer IL1, a second insulating layer IL2 and a metal conductive layer ML, but the invention is not limited thereto. For example, the first insulating layer IL1 and the second insulating layer IL2 are disposed between the control elements 110 and the heaters 120. The metal conductive layer ML is disposed between the first insulating layer IL1 and the second insulating layer IL2. The metal conductive layer ML may include a plurality of conductive patterns CP1, a plurality of conductive patterns CP2 and a plurality of conductive lines CL, but the invention is not limited thereto. In the present embodiment, the material of the metal conductive layer ML may include Al, Mo, Au, Cu, Ta, a combination thereof, or an alloy thereof, but the invention is not limited thereto.

In detail, each of the conductive patterns CP1 penetrates the first insulating layer IL1 to electrically connect the source electrode SE of one of the control elements 110. Each of the conductive patterns CP2 penetrates the first insulating layer IL1 to electrically connect the drain electrode DE of one of the control elements 110. Both end portions of each heater 120 penetrate the second insulating layer IL2 to electrically connect one conductive pattern CP2 and one conductive line CL, respectively. Specifically, each heater 120 is electrically connected to one of the control elements 110 via one conductive pattern CP2 of the metal conductive layer ML, but the invention is not limited thereto. In the present embodiment, for example, the conductive patterns CP1 and the conductive lines CL may be electrically connected to an outer power source to receive driving currents.

It is worth mentioning that the material of the heaters 120 is a transparent conductive material, such that the reliability of the inkjet chip 100 can be improved and the cost of thermal bubble inkjet printhead 10 can be reduced. In the present embodiment, the material of the heaters includes metal oxides (for example, indium-tin oxide, indium-zinc oxide, aluminum tin oxide, aluminum zinc oxide, indium germanium zinc oxide, or other suitable oxides, or stacked layers of at least two of the above). Besides, the film thickness t, specifically the thickness along a normal direction of substrate 101, of each heater 120 may be between 30 nm and (100) nm. The sheet resistance of each heater 120 may be between 10 Ω/sq and 70 Ω/sq.

In the present embodiment, the inkjet chip 100 may further comprise a plurality of conductive patterns 131, a plurality of conductive patterns 132 and a passivation layer PV. For example, the conductive pattern 131 penetrates the second insulating layer IL2 to electrically connect the conductive pattern CP1 of the metal conductive layer ML. The conductive pattern 132 penetrates the second insulating layer IL2 to electrically connect the conductive pattern CP2 of the metal conductive layer ML. Specifically, each control element 110 may be electrically connected to a logical circuit via the conductive pattern 131 and the conductive pattern 132. For example, the logical circuit may include at least one active device, but the invention is not limited thereto. In the present embodiment, the conductive patterns 131, the conductive patterns 132 and the heaters 120 selectively belong to the same film layer, but the invention is not limited thereto.

The passivation layer PV is disposed between the ink barrier 200 and the second insulating layer IL2 and covers the heaters 120, the conductive patterns 131 and the conductive patterns 132. The ink barrier 200 is disposed on the passivation layer PV and has a plurality of ink chambers 200c. Each of the heaters 120 overlaps one of the ink chambers 200c along the normal direction of the substrate 101. The nozzle plate 300 is disposed on the ink barrier 200 and has a plurality of nozzles 300a. The nozzles 300a respectively overlap the ink chambers 200c along the normal direction of the substrate 101. The composition of the ink barrier 200 may include epoxy, polyimide (PI), polyethylene naphthalate (PEN), poly(methyl methacrylate) (PMMA) or siloxane, but the invention is not limited thereto. The composition of the nozzle plate 300 may include epoxy, PI, PEN, PMMA or polycarbonate (PC), but the invention is not limited thereto.

For example, the ink barrier 200 may further comprise a plurality of horizontal ink flow channels (not illustrated). Ink is vertically supplied to these horizontal ink flow channels via an elongated ink slot (not illustrated) which is through the substrate 101 and then enters the corresponding ink chambers 200c through theses horizontal ink flow channels. After that, the ink is vaporized by heaters 120 disposed on the substrate 101 and exposed by the ink chambers 200c so that the ink is ejected through the nozzles 300a on the nozzle plate 300 disposed on the ink chambers 200c to form droplets of ink.

In order to enhance the scratch and abrasion resistance properties of the passivation layer PV, the composition of the passivation layer PV may include silicon nitride, silicon carbide, tantalum, a combination thereof, or other abrasion resistant material, but the invention is not limited thereto. It should be noted that the first insulating layer IL1 and the second insulating layer IL2 can be fulfilled by any method well-known in the art to form any insulating layer used in a display panel. Therefore, information (for example, formation method and composition) about the first insulating layer IL1 and the second insulating layer IL2 will not be described in detail here.

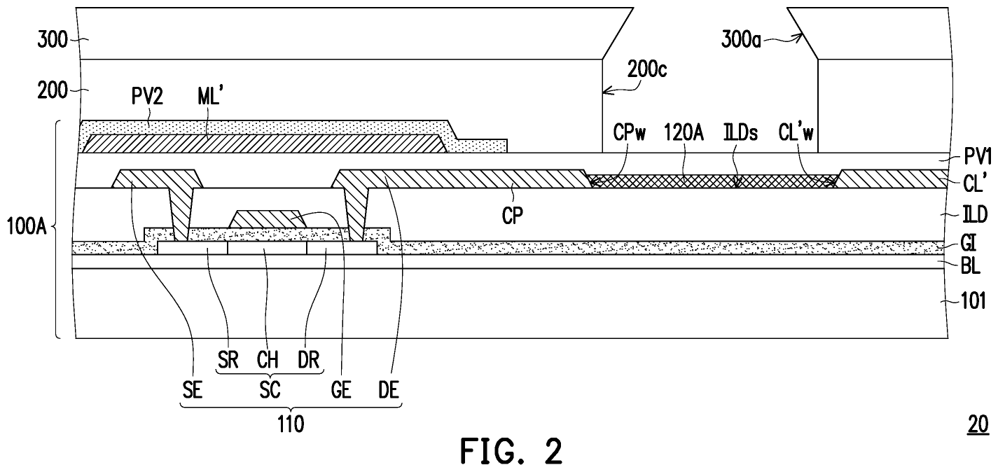

FIG. 2 is a schematic cross-sectional view of a thermal bubble inkjet printhead according to a second embodiment of the invention. Referring to FIG. 2, the difference between the thermal bubble inkjet printhead 20 of the present embodiment and the thermal bubble inkjet printhead 10 of FIG. 1 lies in the physical structure of the inkjet chip. In the present embodiment, the heaters 120A directly cover the surface ILDs of the interlayer dielectric layer ILD. Specifically, both end portions of each of the heaters 120A directly cover a side wall CPw and a side wall CL′w to electrically connect the conductive pattern CP and the conductive line CL′. In the present embodiment, the conductive patterns CP, the conductive lines CL′, the source electrodes SE and the drain electrodes DE selectively belong to the same film layer (for example, the second metal conductive layer), but the invention is not limited thereto.

On the other hand, the first insulating layer IL1 between the metal conductive layer ML and the source electrode SE (or drain electrode DE) and the second insulating layer IL2 covering the metal conductive layer ML illustrated in FIG. 1 are respectively replaced with a passivation layer PV1 and a passivation layer PV2 in the present embodiment. The ink chambers 200c expose a part of the surface of the passivation layer PV1. The metal conductive layer ML′ is disposed between the passivation layer PV1 and the passivation layer PV2. For example, the metal conductive layer ML′ may have a plurality of conductive lines (not illustrated) or a plurality of transfer patterns (not illustrated) to form a part of a logical circuit. It should be understood that the quantity of metal conductive layers may be adjusted to be greater than three basing on the actual circuit design. For example, in other embodiments, additional metal conductive layer could be further included in the inkjet chip and is disposed between the gate electrodes GE (i.e., the first metal conductive layer) and the source electrodes SE (i.e., the second metal conductive layer), but the invention is not limited thereto.

In order to enhance the scratch and abrasion resistance properties of the passivation layer PV1, the composition of the passivation layer PV1 may include silicon nitride, silicon carbide, tantalum, a combination thereof, or other abrasion resistant material, but the invention is not limited thereto.

It is worth mentioning that the material of the heaters 120A is a transparent conductive material, the transparent conductive material includes metal oxides (for example, indium-tin oxide, indium-zinc oxide, aluminum tin oxide, aluminum zinc oxide, indium germanium zinc oxide, or other suitable oxides, or stacked layers of at least two of the above). Such that, the reliability of the inkjet chip 100A can be improved and the cost of thermal bubble inkjet printhead 20 can be reduced.

In summary, the thermal bubble inkjet printhead provided in an embodiment of the disclosure can achieve large-size printing with one inkjet chip whose size may equal to or greater than 4 inches. Specifically, the thermal bubble inkjet printhead of the present invention is not formed by splicing multiple inkjet chips with smaller size so that the quality of printed image can be improved. Besides, the usage of a transparent conductive material to form the heaters of the inkjet chip leads to higher reliability of the inkjet chip and lower cost of thermal bubble inkjet printhead.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Additionally, the abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. It is understood that certain terminology used herein is used for the purpose of describing particular embodiments only and are not intended to be limiting. For example, as used in this specification and the appended claims, the singular forms “a,” “an,” “at least one,” and “the” may include plural referents unless the context clearly dictates otherwise. Any advantages and benefits described may not apply to all embodiments of the invention. It should be appreciated that variations may be made in the embodiments described by persons skilled in the art without departing from the scope of the present invention as defined by the following claims. For example, in the embodiments of the present invention, wherein the heater surrounds the corresponding ink channel in part or entirely, the lead electrically coupled to the heater for conducting current into the heater and the lead electrically coupled to the heater for conducting current out of the heater are not necessary to be arranged adjacent to each other and side by side. Moreover, no element and component in the present disclosure is intended to be dedicated to the public regardless of whether the element or component is explicitly recited in the following claims. These claims may refer to “an” element or “a first” element or the equivalent thereof. Such claims should be understood to include incorporation of one or more such elements, neither requiring nor excluding two or more such elements.

What is claimed is:

1. A thermal bubble inkjet printhead, comprising:
a substrate;
a plurality of control elements, disposed on the substrate;
a plurality of heaters, electrically connected to the control elements, wherein the material of the heaters is a transparent conductive material;
an ink barrier, disposed on the heater, the ink barrier has a plurality of ink chambers, each ink chamber overlaps one of the heaters; and
a nozzle plate, disposed on the ink barrier, and has a plurality of nozzles, each nozzle overlaps one of the ink chambers.

2. The thermal bubble inkjet printhead as claimed in claim 1, wherein the control elements are thin film transistors.

3. The thermal bubble inkjet printhead as claimed in claim 1, wherein the material of the heaters includes metal oxides.

4. The thermal bubble inkjet printhead as claimed in claim 1, further comprising:
a passivation layer, covering the heaters, wherein the ink chambers of the ink barrier expose a part of a surface of the passivation layer, and the material of the passivation layer includes silicon nitride, silicon carbide, tantalum, or a combination thereof.

5. The thermal bubble inkjet printhead as claimed in claim 1, further comprising:
a first insulating layer and a second insulating layer, disposed between the control elements and the heaters; and
a metal conductive layer, disposed between the first insulating layer and the second insulating layer, wherein each of the heaters is electrically connected to one of the control elements via a conductive pattern of the metal conductive layer.

6. The thermal bubble inkjet printhead as claimed in claim 1, wherein each control element includes:
a semiconductor pattern, having a channel region, a source region and a drain region, the source region and the drain region are positioned on two opposite sides of the channel region;
a gate electrode, overlapping the channel region of the semiconductor pattern; and
a source electrode and a drain electrode, electrically connected to the source region and the drain region of the semiconductor pattern, respectively, wherein the gate electrode belongs to a first metal conductive layer, the source electrode and the drain electrode belong to a second metal conductive layer, an interlayer dielectric layer is provided between the first metal conductive layer and the second metal conductive layer, the heaters directly cover the interlayer dielectric layer, and are electrically connected to the drain electrodes of the control elements, respectively.

7. The thermal bubble inkjet printhead as claimed in claim 1, wherein the film thickness of each heater is between 30 nm and 100 nm.

8. The thermal bubble inkjet printhead as claimed in claim 1, wherein the sheet resistance of each heater is between 10 Ω/sq and 70 Ω/sq.

9. An inkjet chip, comprising:
a substrate;
a plurality of control elements, disposed on the substrate; and
a plurality of heaters, electrically connected to the control elements, wherein the material of the heaters is a transparent conductive material.

10. The inkjet chip as claimed in claim 9, wherein the control elements are thin film transistors.

11. The inkjet chip as claimed in claim 9, wherein the material of the heaters includes metal oxides.

12. The inkjet chip as claimed in claim 9, further comprising:
a passivation layer, covering the heaters, and the material of the passivation layer includes silicon nitride, silicon carbide, tantalum, or a combination thereof.

13. The inkjet chip as claimed in claim 9, further comprising:
a first insulating layer and a second insulating layer, disposed between the control elements and the heaters; and
a metal conductive layer, disposed between the first insulating layer and the second insulating layer, wherein each of the heaters is electrically connected to one of the control elements via a conductive pattern of the metal conductive layer.

14. The inkjet chip as claimed in claim 9, wherein each control element includes:
a semiconductor pattern, having a channel region, a source region and a drain region, the source region and the drain region are positioned on two opposite sides of the channel region;
a gate electrode, overlapping the channel region of the semiconductor pattern; and
a source electrode and a drain electrode, electrically connected to the source region and the drain region of the semiconductor pattern, respectively, wherein the gate electrode belongs to a first metal conductive layer, the source electrode and the drain electrode belong to a second metal conductive layer, an interlayer dielectric layer is provided between the first metal conductive layer and the second metal conductive layer, the heaters directly cover the interlayer dielectric layer, and are electrically connected to the drain electrodes of the control elements, respectively.

15. The inkjet chip as claimed in claim 9, wherein the film thickness of each heater is between 30 nm and 100 nm.

16. The inkjet chip as claimed in claim 9, wherein the sheet resistance of each heater is between 10 Ω/sq and 70 Ω/sq.
